(19) United States
(12) Patent Application Publication
(10) Pub. No.: US 2026/0024132 A1
(43) Pub. Date: Jan. 22, 2026

(54) WRIST NAVIGATION TOOL FOR VIRTUAL REALITY RETAIL ENVIRONMENT

(71) Applicant: TARGET BRANDS, INC., Minneapolis, MN (US)

(72) Inventors: Corey Hadden, Minneapolis, MN (US); Kristi A. Stewart, Minneapolis, MN (US); James A. Miller, Minneapolis, MN (US); Amanda Powell, Minneapolis, MN (US); Mark Lofthus, Minneapolis, MN (US)

(21) Appl. No.: 19/273,920

(22) Filed: Jul. 18, 2025

Related U.S. Application Data
(60) Provisional application No. 63/672,868, filed on Jul. 18, 2024.

(51) Int. Cl. G06Q 30/0601; G06F 3/04815; G06F 3/0482; G06F 3/04886

(52) U.S. Cl. CPC G06Q 30/06442; G06F 3/04886; G06Q 30/0625; G06Q 30/06435; G06F 3/04815; G06F 3/0482

(57) ABSTRACT

Computer-implemented methods and systems to present a virtual reality wrist navigation tool in a virtual reality retail environment of a retailer online service are provided. The methods and systems allow one or more guests to navigate products/services provided by the retailer online service within virtual reality retailer environments in an easy, accessible, and entertaining manner. The wrist navigation tool allows guests to readily view and select different information and options available within the virtual reality retail environment. The computer-implemented methods and systems can allow one or more guests to navigate different hubs, scenes, experiences, activities, products, and/or services provided by the retailer online service within virtual reality retailer environments in an easy, accessible, and entertaining manner.

### FIELD

This disclosure relates generally to virtual reality retail environments. More specifically, this disclosure relates to systems and methods for providing a wrist navigation tool within a virtual reality retail environment.

### BACKGROUND

Online retail shopping continues to evolve as retailer online services look for new ways of increasing engagement with guests visiting the retailer online service. Guests are spending more time in virtual reality retail environments. Creating engagement between the retailer online service and guests via virtual reality retail environments is desirable.

### SUMMARY

This disclosure relates generally to virtual reality (VR) retail environments. More specifically, this disclosure relates to systems and methods for providing a wrist navigation tool within a virtual reality retail environment.

The embodiments described herein provide computer-implemented methods and systems to present graphical user interfaces in a virtual reality retail environment of a retailer online service. In particular, the embodiments disclosed herein are directed to a virtual wrist navigation tool that allows guests to readily view and select different information and options available within the virtual reality retail environment. The computer-implemented methods and systems can allow one or more guests (also referred to herein as “users”) to navigate different hubs, scenes, experiences, activities, products, and/or services provided by the retailer online service within virtual reality retailer environments in an easy, accessible, and entertaining manner.

In some embodiments, the information and options viewable and selectable on the wrist navigation tool can dynamically change in real time based on, for example, one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products, services and experiences of the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc.

Accordingly, the virtual wrist navigation tool can increase the ease and accessibility in which the guest can interact with the virtual reality retail environment, increase the entertainment value of the virtual reality retail environment to the guest, and thereby enhance the guest's experience within the virtual reality retail environment.

In one embodiment, a computer-implemented method to present a graphical user interface in a virtual reality retail environment of a retailer online service. The computer-implemented method includes receiving, via an input device, a wrist navigation tool command to present a wrist navigation tool within the virtual reality retail environment. The computer-implemented method also includes, upon receiving the wrist navigation tool command, determining information and options to be displayed on the wrist navigation tool. Further, the computer-implemented method includes causing, via a display device, presentation of the wrist navigation tool within the virtual reality retail environment, the wrist navigation tool being aligned within a field of view of a user, and the wrist navigation tool including a search bar segment, a shared display segment, and a global navigation segment, wherein the shared display segment includes the information and the options determined to be displayed on the wrist navigation tool. Moreover, the computer-implemented method includes receiving, via the input device, a selection command to select an option provided in at least one of the shared display segment and the global navigation segment. The computer-implemented method also includes, upon receiving the selection command: determining updated information and options to be displayed on the wrist navigation tool, and causing, via the display device, at least one of: presentation of an updated shared display segment with the updated information and options on the wrist navigation tool based on the selection command, and transporting a guest avatar of a guest to a different location within the virtual reality retail environment based on the selection command.

In another embodiment, a system configured to present a graphical user interface in a virtual reality retail environment is provided. The system includes a retailer online service that is configured to receive, via an input device, a wrist navigation tool command to present a wrist navigation tool within the virtual reality retail environment. The retailer online service is also configured to, upon receiving the wrist navigation tool command, determine information and options to be displayed on the wrist navigation tool. The retailer online service is also configured to cause, via a display device, presentation of the wrist navigation tool within the virtual reality retail environment, the wrist navigation tool being aligned within a field of view of a guest, and the wrist navigation tool including a search bar segment, a shared display segment, and a global navigation segment, wherein the shared display segment includes the information and the options determined to be displayed on the wrist navigation tool. The retailer online service is also configured to receive, via the input device, a selection command to select an option provided in at least one of the shared display segment and the global navigation segment. Upon receiving the selection command, the retailer online service is configured to: determine updated information and options to be displayed on the wrist navigation tool, cause, via the display device, at least one of: presentation of an updated shared display segment with the updated information and options on the wrist navigation tool based on the selection command, and transport of a guest avatar of a guest to a different location within the virtual reality retail environment based on the selection command.

### BRIEF DESCRIPTION OF THE DRAWINGS

References are made to the accompanying drawings that form a part of this disclosure and which illustrate embodiments in which the systems and methods described in this specification can be practiced.

FIG. 1 illustrates a schematic diagram of a system for providing a virtual wrist navigation tool within one or more virtual reality retail environments, according to one embodiment.

FIG. 2 illustrates a flowchart of a method for presenting a virtual wrist navigation tool within one or more virtual reality retail environment(s), according to one embodiment.

FIGS. 3A-3B illustrate different screenshots of a virtual reality retail environment that can present a virtual wrist navigation tool. FIG. 3A illustrates a screenshot of a virtual reality retail environment that can present a virtual wrist navigation tool upon receiving a command to initiate display of the wrist navigation tool, according to one embodiment. FIG. 3B illustrates a screenshot of a virtual reality retail environment in which a wrist navigation tool on the arm of the guest avatar is shown upon the guest sending a command to initiate the wrist navigation tool.

FIGS. 4A-L illustrate different schematic representations of how a virtual wrist navigation tool can be used within a virtual reality retail environment. FIG. 4A illustrates a generic schematic representation of the virtual wrist navigation tool, according to one embodiment. FIG. 4B illustrates a schematic representation of the virtual wrist navigation tool displaying a home display, according to one embodiment. FIG. 4C illustrates a schematic representation of the virtual wrist navigation tool displaying a home display when the guest selects the keyword search bar, according to one embodiment. FIG. 4D illustrates a screenshot of a virtual reality retail environment in which a keyboard is displayed that is aligned within the field of view of the guest when the guest selects the keyboard search bar, according to one embodiment. FIG. 4E illustrates a schematic representation of the virtual wrist navigation tool displaying a home display when the guest selects the search button after typing one or more search terms into the keyword search bar, according to one embodiment. FIG. 4F illustrates a screenshot of a portion of the virtual reality retail environment showing search results in the keyboard mode after the guests types one or more search terms into the keyword search bar or the keyboard, according to one embodiment. FIG. 4G illustrates a screenshot of a portion of the virtual reality retail environment showing search results in the filter mode after the guests types one or more search terms into the keyword search bar or the keyboard, according to one embodiment. FIG. 4H illustrates a schematic representation of the virtual wrist navigation tool upon selection of the Map button, according to one embodiment. FIG. 4I illustrates a schematic representation of the virtual wrist navigation tool upon selection of the Camera button, according to one embodiment. FIG. 4J illustrates a schematic representation of the virtual wrist navigation tool upon selection of the Scan Tool button, according to one embodiment. FIG. 4K illustrates a schematic representation of the virtual wrist navigation tool upon selection of the Shopping Cart button, according to one embodiment. FIG. 4L illustrates a schematic representation of the virtual wrist navigation tool when the guest is attempting to link the guest avatar to an account with the retailer online service, according to one embodiment.

FIG. 5 illustrates a schematic diagram of architecture for a computer device, according to one embodiment.

Like reference numbers represent like parts throughout.

### DETAILED DESCRIPTION

This disclosure relates generally to virtual reality (VR) retail environments. More specifically, this disclosure relates to systems and methods for providing a wrist navigation tool within a virtual reality retail environment.

The embodiments described herein provide computer-implemented methods and systems to present graphical user interfaces in a virtual reality retail environment of a retailer online service. In particular, the embodiments disclosed herein are directed to a virtual wrist navigation tool that allows guests to readily view and select different information and options available within the virtual reality retail environment. The computer-implemented methods and systems can allow one or more guests (also referred to herein as “users”) to navigate different hubs, scenes, experiences, activities, products, and/or services provided by the retailer online service within virtual reality retailer environments in an easy, accessible, and entertaining manner.

In some embodiments, the information and options viewable and selectable on the wrist navigation tool can dynamically change in real time based on, for example, one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products, services and experiences of the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc.

Accordingly, the virtual wrist navigation tool can increase the ease and accessibility in which the guest can interact with the virtual reality retail environment, increase the entertainment value of the virtual reality retail environment to the guest, and thereby enhance the guest's experience within the virtual reality retail environment.

The embodiments described herein provide computer-implemented methods and systems to present graphical user interfaces in a virtual reality retail environment of a retailer online service. The computer-implemented methods and systems can allow one or more guests to navigate products/services provided by the retailer online service within virtual reality retailer environments in an easy, accessible, and entertaining manner. In particular, the embodiments disclosed herein can allow one or more guests (also referred to herein as “users”) to navigate products and services provided by a retailer online service within virtual reality retailer environments in an easy, accessible, and entertaining manner. In particular, the embodiments disclosed herein are directed to a virtual wrist navigation tool that allows guests to readily view and select different options available within the virtual reality retail environment.

In some embodiments, the options viewable and selectable on the wrist navigation tool can dynamically change based on, for example, one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products, services and experiences of the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc.

Accordingly, the virtual wrist navigation tool can increase the ease and accessibility in which the guest can interact with the virtual reality retail environment, increase the entertainment value of the virtual reality retail environment to the guest, and thereby enhance the guest's experience within the virtual reality retail environment.

As defined herein, a retailer GUI can be, for example, a website, an app, etc. that allows guests to browse, shop for, and purchase products available for purchase from a retailer.

A virtual reality retail environment, as defined herein, refers to a virtual-reality space in which guests can experience and interact with a computer-generated retail environment and other guests.

Examples of retail services can include, for example, selling optical glasses, subscription to a beauty box service, nail salon services, air time with a mobile carrier, assembly and installation, device repair, bike repair, order pickup (e.g., drive up order pickup, store order pickup, etc.), store events (e.g., back to college event(s), parking lot/park concert(s), trick or treat event(s), reading event(s), etc.), quick response (QR) code scanning in retailer catalogue, QR code scanning on a user device, etc.

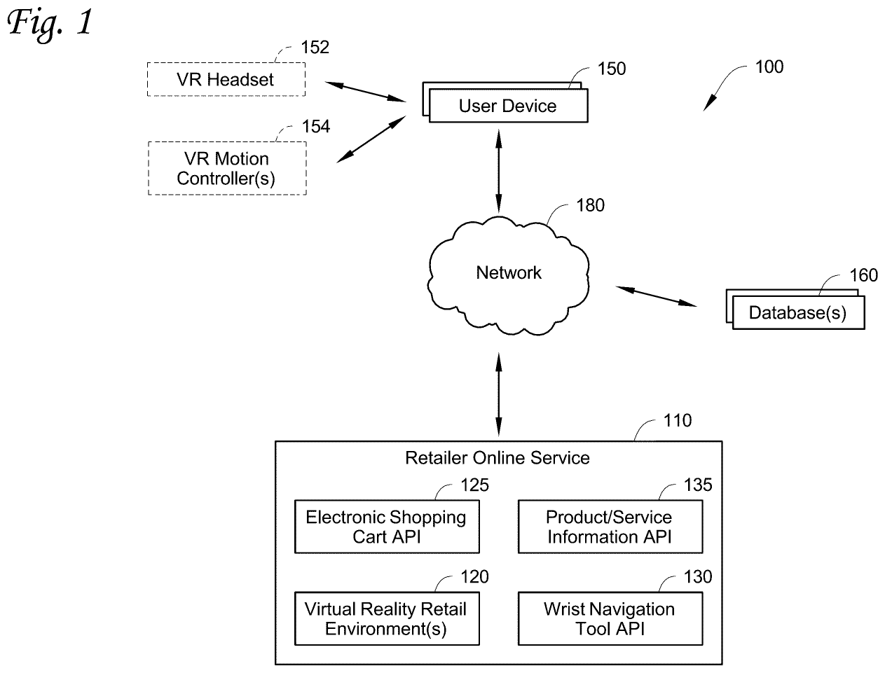

FIG. 1 is a schematic diagram of a system 100 for providing a virtual wrist navigation tool within one or more virtual reality retail environments 120, according to one embodiment. The system 100 includes a retailer online service 110, one or more user devices 150, one or more database(s) 160, and a network 180 connecting the retailer online service 110, the one or more user devices 150, and the one or more database(s) 160.

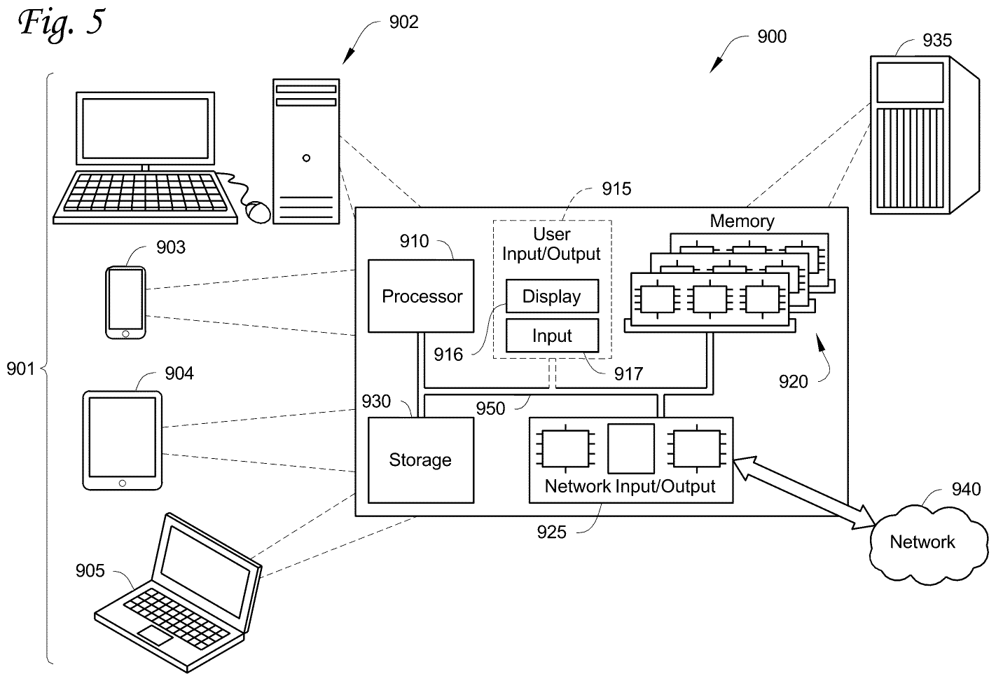

The retailer online service 110 includes the virtual reality retail environment(s) 120, a shopping cart application programming interface (API) 125, a virtual wrist navigation tool API 130, and a product/service/experience/activity information API 135. The retailer online service 110 is configured to provide an online retail experience for guests accessing the virtual reality retail environment(s) 120 via the one or more user devices 150. It will be appreciated that in other embodiments, the retailer online service 110 can include more or less APIs than those shown in FIG. 1 as required to perform the methods and systems described herein. In some embodiments, aspects of the retailer online service 110 can be the same as or similar to aspects of the server device 935 shown and described in accordance with FIG. 5 below.

The virtual reality retail environment(s) 120 is configured to provide a virtual-reality space in which guests can interact with a computer-generated environment and other guests. The virtual reality retail environment(s) 120 can replicate real and imaginary environments and simulate a guest's physical presence in those environments. This can be achieved using a combination of hardware and software that renders visual, audial, and tactile feedback based on guest movements and input. In some embodiments, this input can be through simple devices, such as a mouse, keyboard or gaming controller. In more advanced embodiments, physical motion of the guest can be tracked by using sensors placed on the guest or by analyzing real-time video of the guest, or a combination of both. The visual and audial rendering can be presented via a headset, Head Mounted Display (HMD), worn by the guest, although any mechanism that presents guest localized audio and video could be used. Tactile or haptic feedback can be given by a plethora of control devices, including but not limited to, hand held controllers with rumble motors, gloves, full and partial-body suits, chairs, controlled air flows and immersive smart-fluids. In addition, some environments supply smell and taste based sensory feedback.

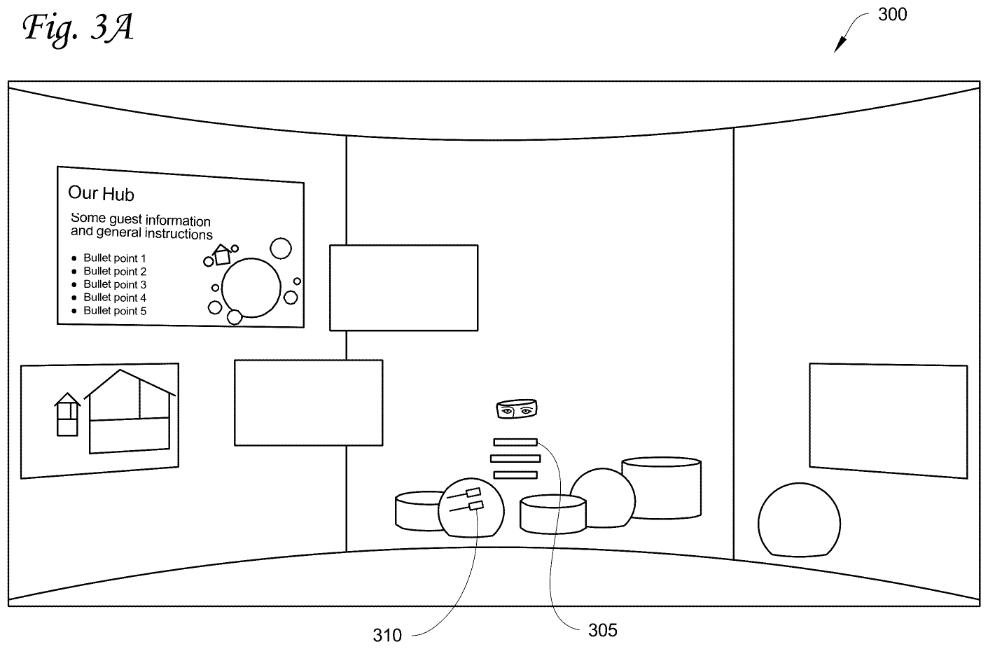

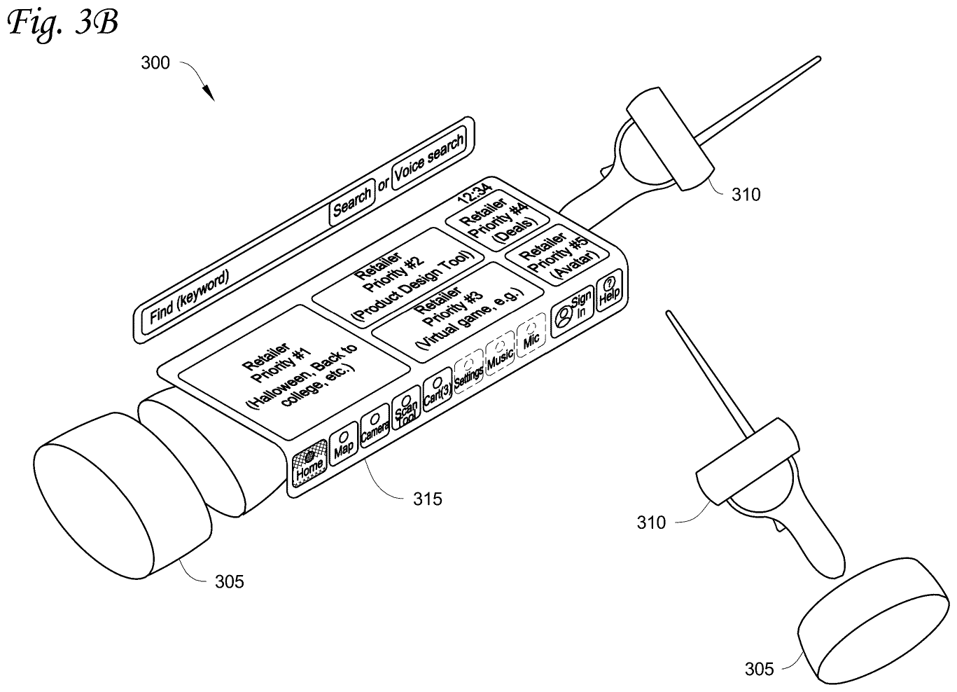

In some embodiments, the virtual reality retail environment(s) 120 allow one or more guest(s), via the one or more user devices 150, to view or experience, browse, interact with, shop for, and purchase products and services from the retailer online service 110. The virtual reality retail environment(s) GUI 120 can also be configured to provide opportunities for guest participation or action with retailer curated events or promotions. The virtual reality retail environment(s) 120 can be accessed by the user device(s) 150 via a website, an app, etc. While the virtual reality retail environment(s) 120 are shown as part of the retailer online service 110, it will be appreciated that in other embodiments the virtual reality retail environment(s) can be downloaded or saved on the user device(s) 150. FIGS. 3A-3S, described below, illustrate different screenshots of content that may be displayed on the virtual reality retail environment(s) 120.

In some embodiments, the virtual reality retail environment(s) 120 can display a guest avatar representing a virtual representation of the guest at a particular location within the virtual reality retail environment(s) 120. The guest avatar can include a virtual representation of input/output device(s) being used by the guest (e.g., optional VR motion controller(s) 154).

The electronic shopping cart API 125 is configured to provide and store an electronic shopping cart for use by a guest while the guest is in the virtual reality retail environment(s) 120. That is, a guest can select one or more products or services provided in a card ecosystem guest interface for purchase and the one or more products or services are provided in the guest's electronic shopping cart that is maintained by the electronic shopping cart API 125.

The virtual reality retail environment(s) 120 can access, for example, different APIs from the retailer online service 110 (e.g., the wrist navigation tool API 130, the product/service/experience/activity information API 135, etc.) to retrieve and display real time and dynamic information and selectable options using the wrist navigation tool API 130. Accordingly, the virtual reality retail environment(s) 120 are not required to load static data regarding products or services provided by the retailer online service 110 when the virtual reality retail environment(s) is opened or loaded on the one or more user devices 150.

The wrist navigation tool API 130 is configured to provide a wrist navigation tool within the virtual reality retail environment(s) 120. In some embodiments, the wrist navigation tool API 130 can allow one or more guests to navigate different hubs, scenes, experiences, activities, products, and/or services provided by the retailer online service within virtual reality retailer environments in an easy, accessible, and entertaining manner. Accordingly, the wrist navigation tool API 130 can provide a virtual wrist navigation tool that allows guests to readily view and select different information and options available within the virtual reality retail environment(s) 120. In some embodiments, the wrist navigation tool API 130 can provide options viewable and selectable on a wrist navigation tool can dynamically change based on, for example, one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products, services and experiences of the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc.

In some embodiments, the information and options viewable and selectable on the wrist navigation tool can dynamically change in real time based on, for example, one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products, services and experiences of the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc.

The product/service/experience/activity information API 135 is configured to communicate with the one or more database(s) 160, the virtual reality retail environment(s) 120, and the wrist navigation tool interface API 130. In particular, the product/service/experience/activity information API 135 is configured to receive instructions from the virtual reality retail environment(s) 120 requesting product/service/experience/activity data stored in the one or more database(s) 160. The product/service/experience/activity information API 135 is then configured to communicate with the one or more database(s) 160 to retrieve the requested product/service/experience/activity data and then configured to extract product/service/experience/activity specific information regarding the product, service, experience or activity for interaction within the virtual reality retail environment. In some embodiments, extracting the product/service/experience/activity specific information can include extracting 3D model data in order to provide the requested product/service/experience/activity specific information and the 3D model data to the virtual reality retail environment(s) 120. The product/service/experience/activity information API 135 can also be configured to filter search results based on commands received from the guest via the virtual reality retail environment(s) 120 (e.g., via a virtual wrist navigation tool).

In some embodiments, the product/service/experience/activity information API 135 is configured to receive instructions from the virtual reality retail environment(s) 120, communicate with the one or more database(s) 160 to retrieve the requested product/service/experience/activity specific information, and provide the requested product/service/experience/activity specific information to the virtual reality retail environment(s) 120 in real time. When a guest performs a search using the wrist navigation tool provided by the wrist navigation tool API 130, the product/service/experience/activity information API 135 can pull real time product/service/experience/activity data from the one or more database(s) 160 and then transfer the data to the virtual reality retail environment(s) 120 in real time. The data retrieved by the product/service/experience/activity information API 135 in real time from the one or more database(s) 160 can include 3D model data used to display a 3D model of a product in the virtual reality retail environment(s) that can be interacted with by the guest.

The virtual reality retail environment(s) 120, the electronic shopping cart API 125, the wrist navigation tool API 130, and the product/service/experience/activity information API 135 may be implemented as separate hardware capable of performing different functionalities of the retailer online service 110. The virtual reality retail environment(s) 120, the electronic shopping cart API 125, the wrist navigation tool API 130, and the product/service/experience/activity information API 135 may include routines, programs, objects, components, data structures, and the like, which perform particular tasks or implement particular abstract data types. The virtual reality retail environment(s) 120, the shopping cart API 125, the wrist navigation tool API 130, and the product/service/experience/activity information API 135 may further include electronic circuitry or a combination of electronic circuitry and control programs that operate the components according to the functions described herein.

The one or more user devices 150 are configured to access the one or more virtual reality retail environments 170 via the network 180. The one or more user devices 150 are the same as or similar to aspects of the computer device 900 as shown and described in accordance with FIG. 5 below. The user device(s) 150 can include, but are not limited to, a desktop computer, a cellular/mobile phone, a tablet device, a laptop computer, video game console, etc. The one or more user devices 150 can be part of or connected to one or more input/output devices including an optional VR headset 152 and/or one or more optional motion controller(s) 154. The VR headset 152 can allow a guest to experience visual images and sounds associated with the virtual reality retail environment(s) 120. In some embodiments, the VR headset 152 can display a 3D virtual scene and can include sensors to track a user's head movement to show different portions of the virtual reality retail environment(s) 120. In some embodiments, the VR headset 152 can include a microphone that allows the guest to speak to other guests experiencing the virtual reality retail environment(s) 120. The one or more VR motion controller(s) 154 can allow a guest to interact with different objects within the virtual reality retail environment(s) 120. In some embodiments, the one or more motion controllers 154 can include sensors to track a user's motions (e.g., hand motions) and can include buttons and controls to move a camera or guest around the virtual reality retail environment(s) 120. In some embodiments, the one or more motion controllers 154 can allow the guest to navigate the virtual reality retail environment(s) 120 by waving the motion controller(s) 154 to create gesture commands. Also, in some embodiments, the one or more motion controllers 154 can allow the guest to navigate the virtual reality retail environment(s) 120 by allowing the guest to look at different locations within the virtual reality retail environment(s) 120 using the VR headset 152 and teleport or jump to a location the guest is looking at by using a button or control on the one or more VR controller(s) 154. In some embodiments, the one or more user devices 150 can be part of or connected to other input/output devices including, for example, goggles, other wearable computing device(s), joystick(s), etc. that may provide haptic or tactile outputs and/or feedback related to portions of the experience within the virtual reality retail environment(s) 120.

The one or more database(s) 160 is configured to store product/service/experience/activity data for products, or services sold by the retailer online service 110 and/or experiences and activities provided by the retailer online service. The product/service/experience/activity data can include product/service/experience/activity specific information and 3D model data. The product/service/experience/activity specific information can include, for example, the name of the product or service, the name of the company selling the product or service, the price of the product or service, color options for the product or service, customer review(s) of the product or service, specific details of the product or service, warranty information of the product or service, size and/or weight of the product, etc. The product/service/experience/activity specific information can also include various pictures of the product or service.

As noted above, the one or more database(s) 160 is also configured to store 3D model data of any products or services sold by the retailer online service 110. In some embodiments, the 3D model data can be used for rendering a 3D model of a product for display on a two-dimensional display (e.g., a computer monitor, a tablet display, a mobile phone display, etc.) and in a 3D virtual reality retail environment.

In some embodiments, the product/service/experience/activity data stored in the one or more database(s) 160 can be used in multiple platforms of the retailer online service 110 including, for example, the virtual reality retail environment(s) 120 and two dimensional retail applications (e.g., retailer websites, retailer shopping apps, etc.). Accordingly, the product/service/experience/activity data can be used across different platforms of the retailer online service 110 without having to create different assets or files to accommodate each retailer platform.

In some embodiments, the virtual reality retail environment(s) 120 can display scaled 3D model(s) of products or services available for purchase from the retailer online service 110. The virtual reality retail environment(s) 120 can automatically and continuously select one of a plurality 3D model versions as a scaled 3D model for display based on a distance from a guest avatar within the virtual reality retail environment(s) 120 and the scaled 3D model. For example, a higher fidelity 3D model version of the plurality of 3D model versions can be selected for display as the scaled 3D model when the guest avatar is within a predefined threshold distance from the scaled 3D model and a lower fidelity 3D model version of the plurality of 3D model versions can be selected for display on the display device as the scaled 3D model when the guest avatar is outside of the predefined threshold distance from the scaled 3D model. In some embodiments, the virtual reality retail environment(s) 120 can automatically select one of the plurality of 3D model versions to display as a miniature 3D model. In some embodiments, the 3D model version selected for the miniature 3D model version may not be the highest fidelity level 3D model version of the plurality of 3D model versions.

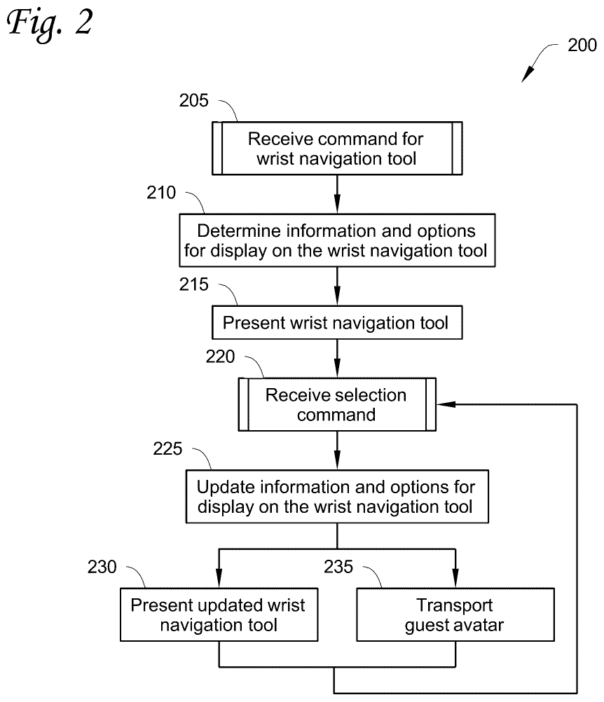

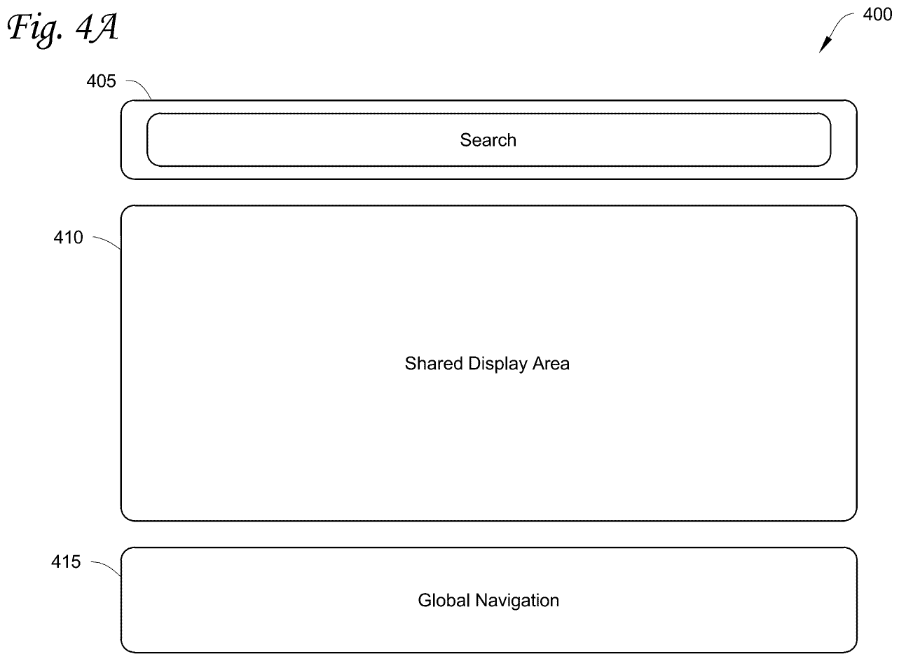

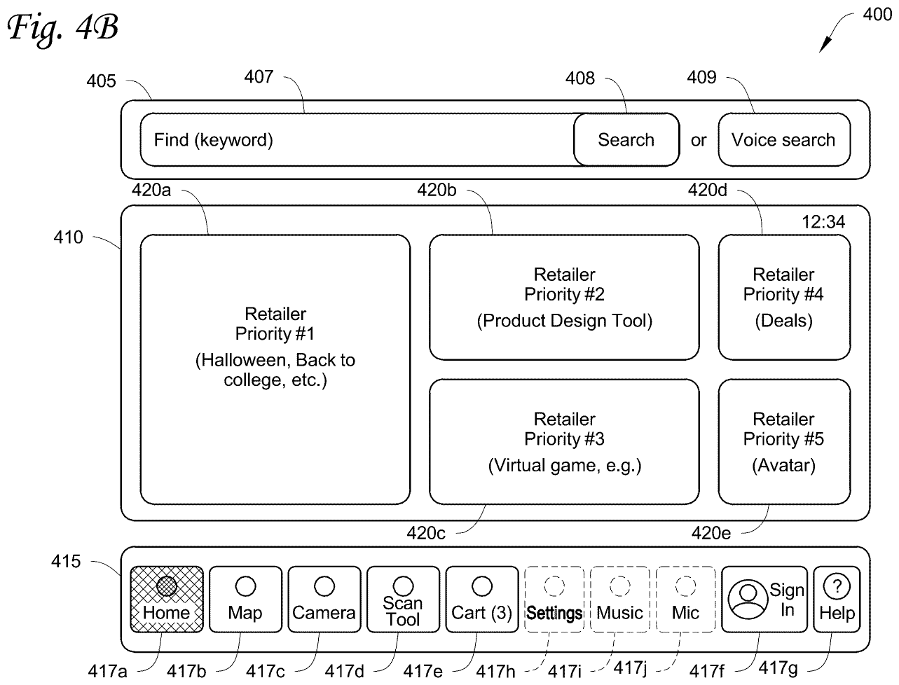

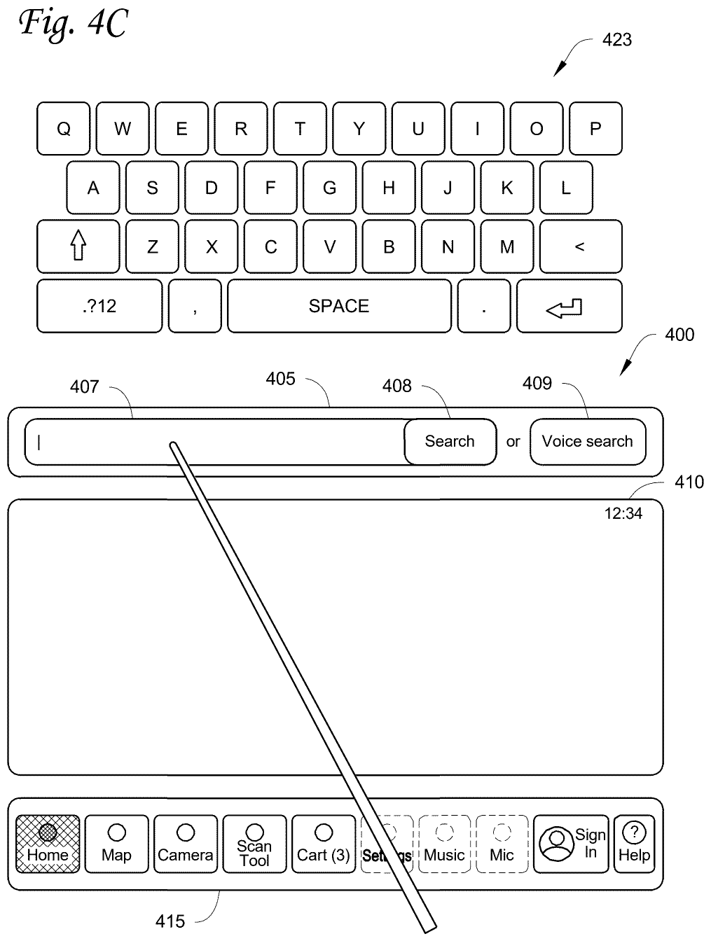

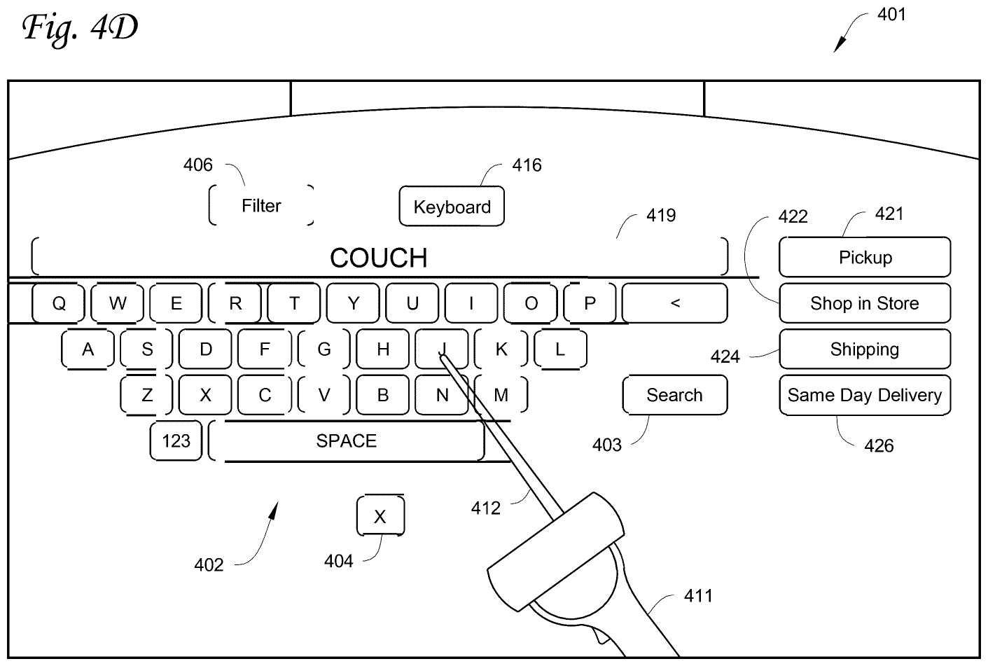

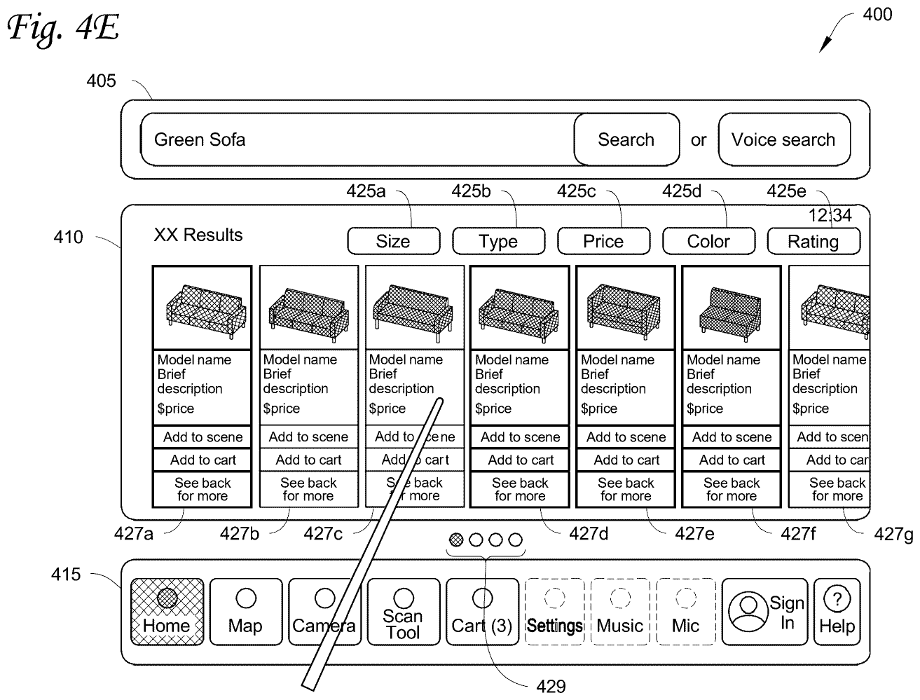

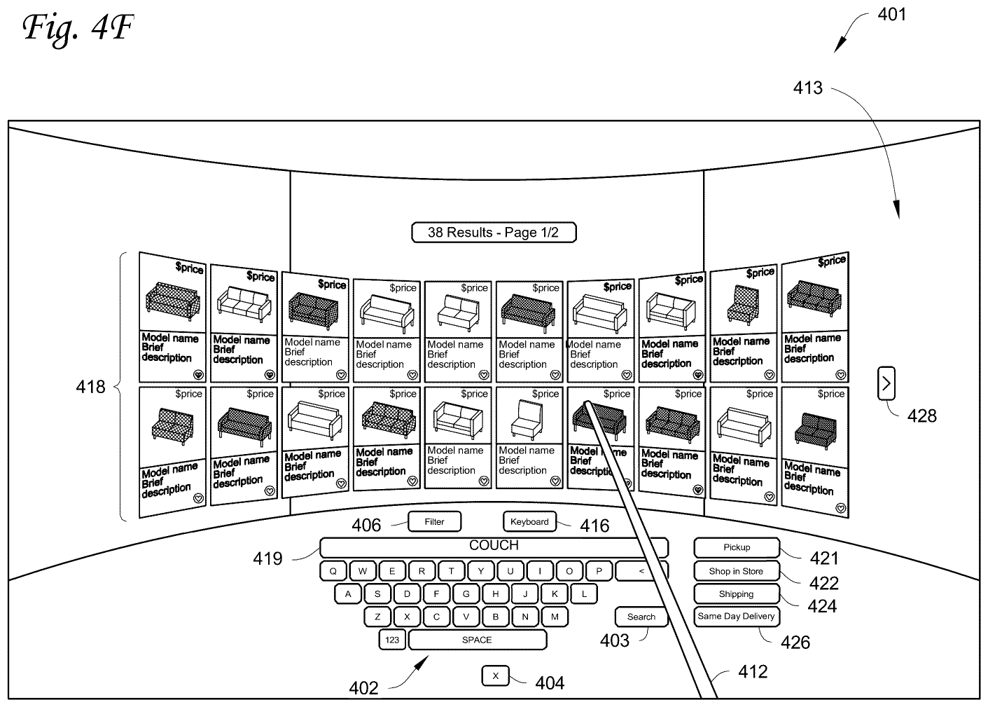

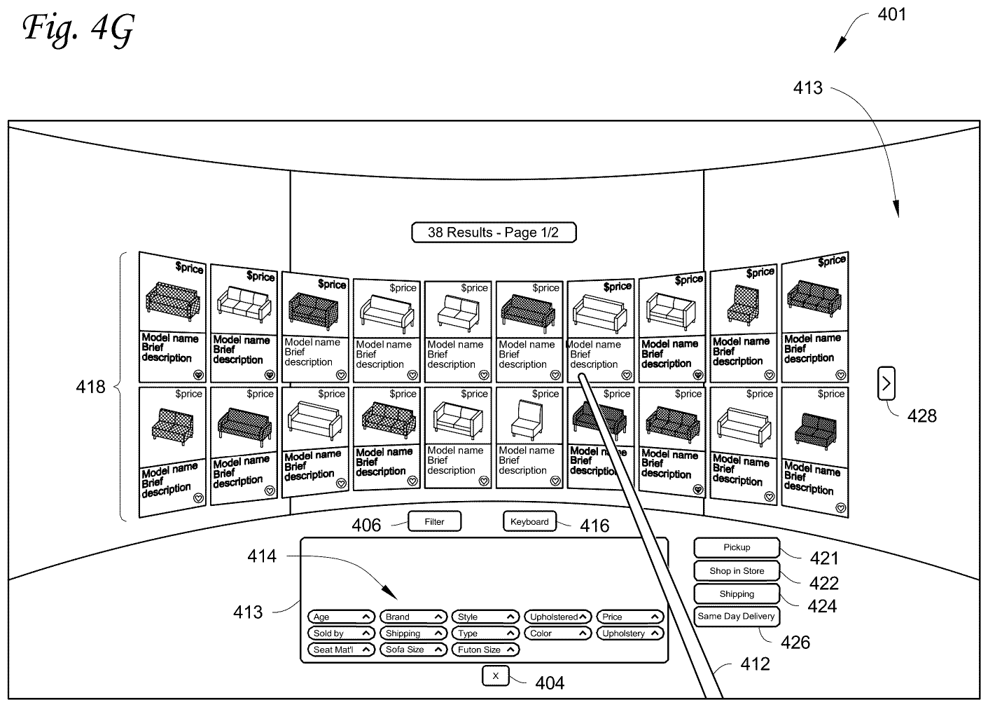

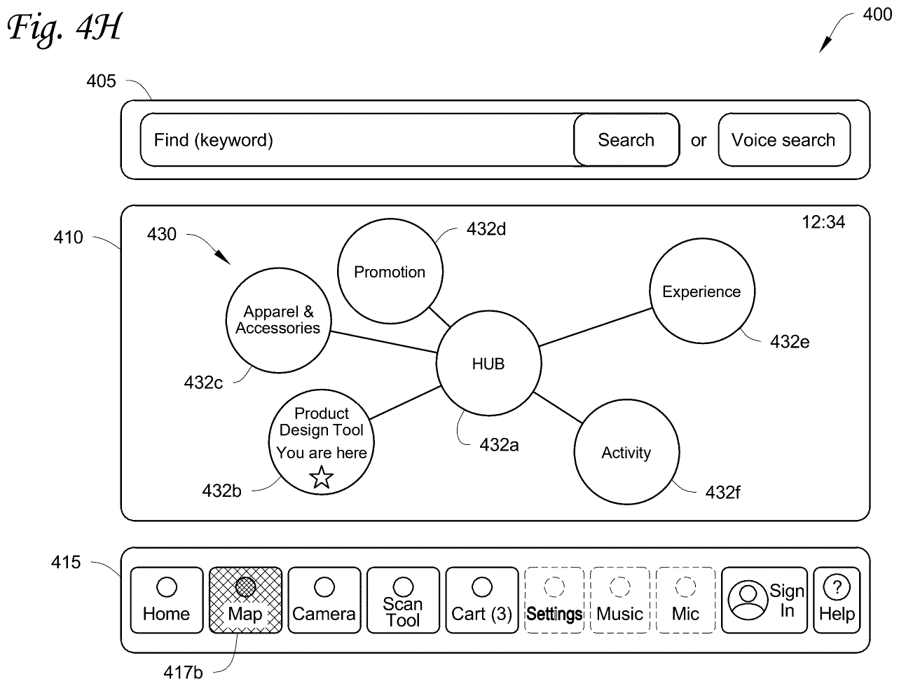

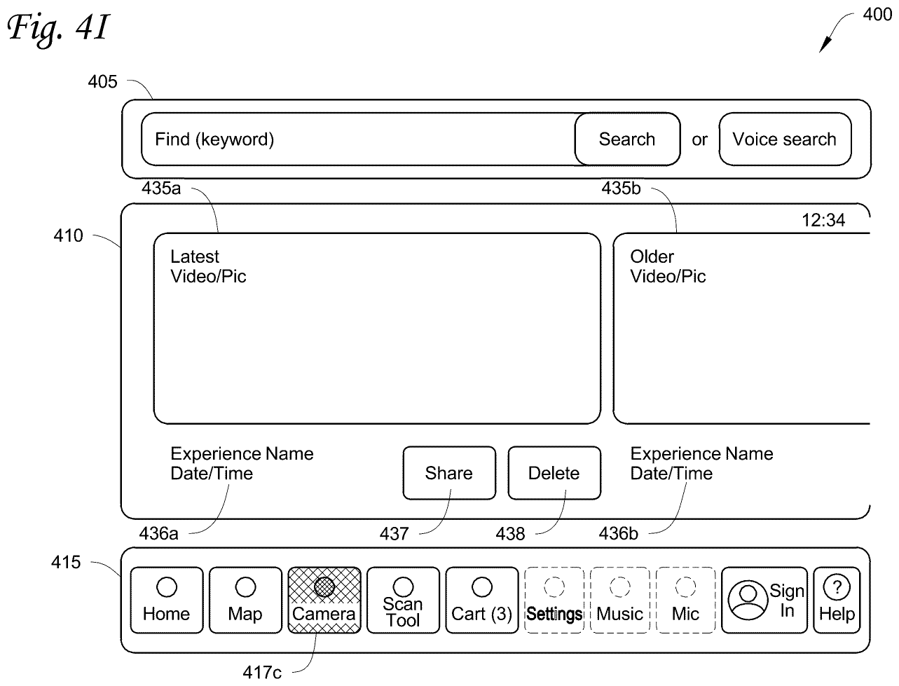

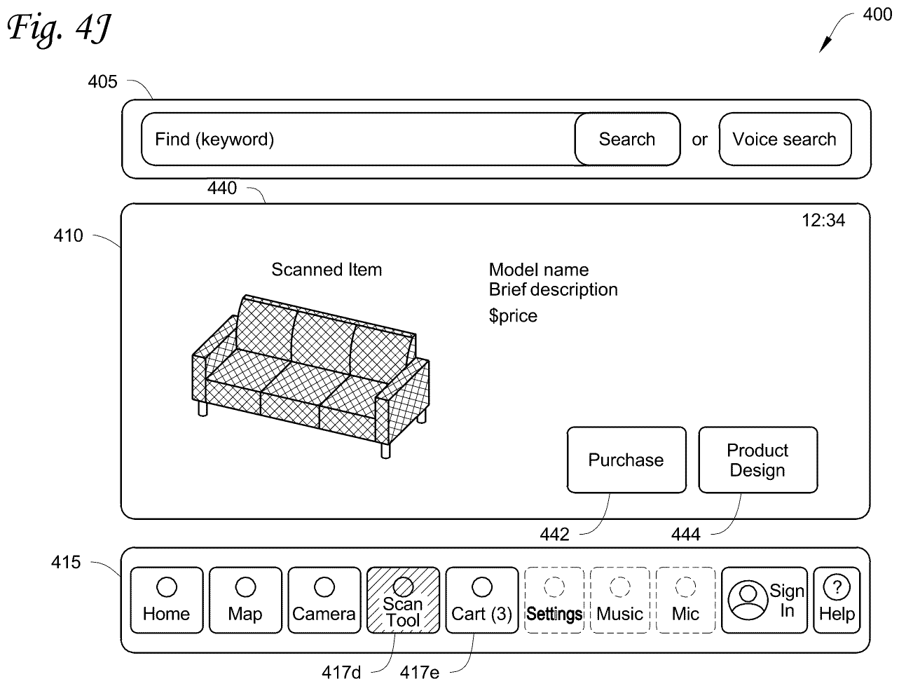

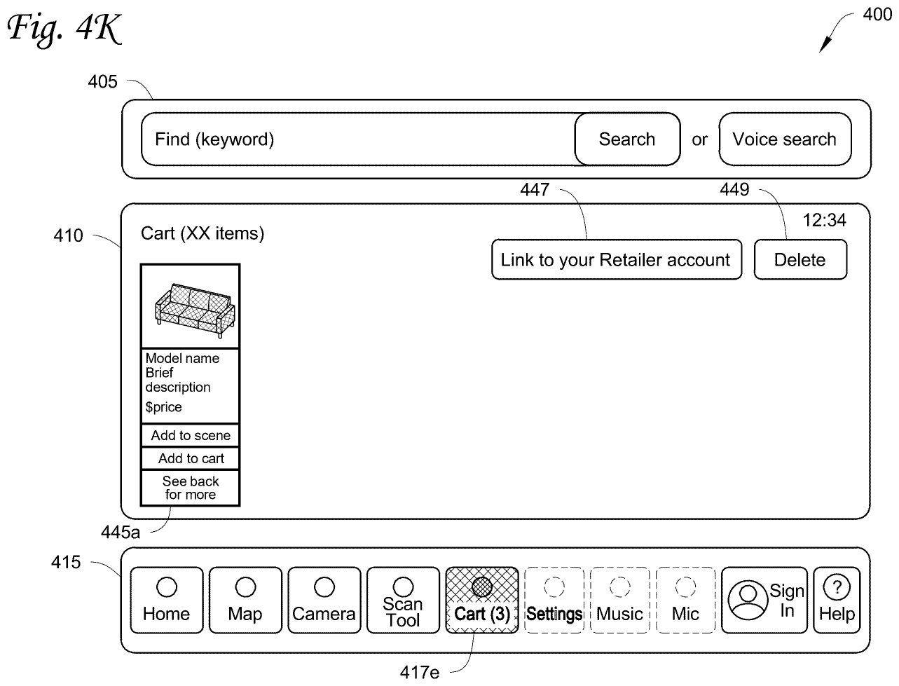

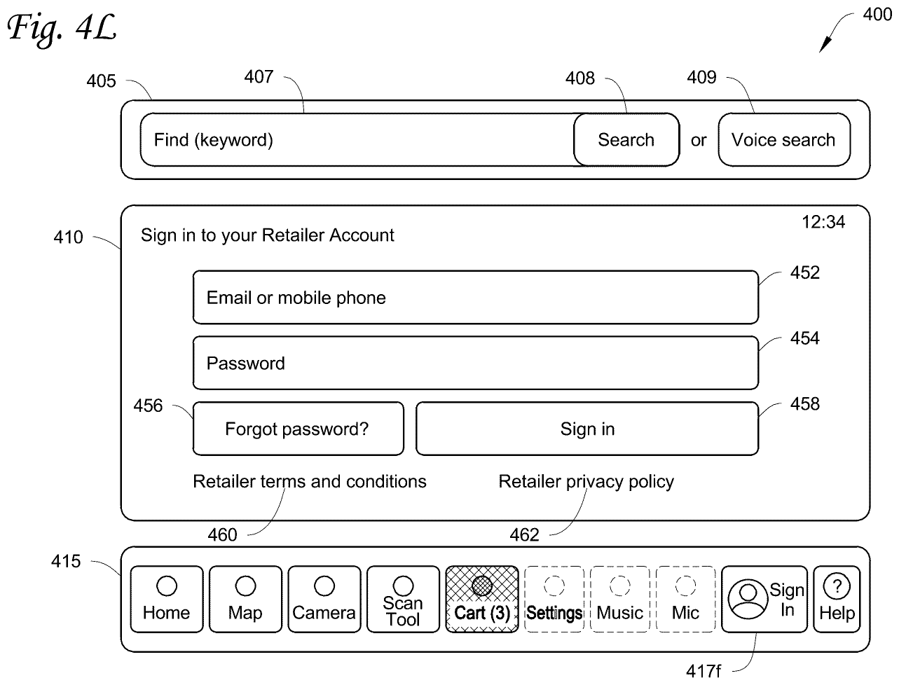

FIG. 2 illustrates a flowchart of a method 200 for presenting a virtual wrist navigation tool within one or more virtual reality retail environment(s). In some embodiments, the method 200 can be implemented using the system 100 shown in FIG. 1. The method 200 can allow one or more guests to navigate different hubs, scenes, experiences, activities, products, and/or services provided by a retailer online service (e.g., the retailer online service 110 shown in FIG. 1) within virtual reality retailer environment(s) (e.g., the virtual reality retail environment(s) 120 shown in FIG. 1) in an easy, accessible, and entertaining manner. In particular, the method 200 can a virtual wrist navigation tool that allows guests to readily view and select different information and options available within the virtual reality retail environment. For illustrative purposes, the method 200 is described below with respect to one non-limiting example of how a wrist navigation tool can be implemented in a virtual reality retail environment as provided in the screenshots shown in FIGS. 3A-B and the schematic of a wrist navigation tool shown in FIGS. 4A-L.

At 205, a retailer online service receives a wrist navigation tool command over a network (e.g., the network 180 shown in FIG. 1) from a guest experiencing the virtual reality retail environment to present a wrist navigation tool within the virtual reality retail environment. In some embodiments, the guest can send a command through a user device (e.g., the user device(s) 150 shown in FIG. 1) using, for example, an input/output device (e.g., the VR motion controller 154 shown in FIG. 1) connected to the user device. For example, a guest can press a button or control on a VR motion controller to initiate display of the wrist navigation tool. In another example, a guest can lift the VR motion controller to their face to initiate display of the wrist navigation tool. In yet another example, a guest can use the VR motion controller to select a wrist menu option provided in the virtual reality retail environment. That is, for example, the guest can select a virtual button located on a virtual representation of the input/output device being used by the guest (e.g., a virtual representation of the VR motion controller(s) 154). It will be appreciated that any combination of the examples discussed can be used by the guest to command the virtual reality retail environment to present the wrist navigation tool. Also, it will be appreciated that, in some embodiments, the guest can access or remove presentation of the wrist navigation tool as desired by sending a command through the user device.

The method 200 then proceeds to 210.

FIG. 3A illustrates a screenshot of a virtual reality retail environment 300 that can present a virtual wrist navigation tool upon receiving a command to initiate display of the wrist navigation tool. The virtual reality retail environment 300 includes a guest avatar 305 that provides a visual representation of the guest within the virtual reality retail environment 300. The guest avatar 305 includes a virtual representation of an input/output device 310 being used by the guest (e.g., a virtual representation of the VR motion controller(s) 154). As discussed above at 205, the guest can send a command using an input/output device to initiate display of the wrist navigation tool within the virtual reality retail environment 300.

Returning to FIG. 2, at 210, a wrist navigation tool API (e.g., the wrist navigation tool API130) determines information and options to be displayed on the wrist navigation tool.

In some embodiments, database(s) (e.g., the databases 160) can provide information and options for the identified relevant (or potentially relevant) activities, experiences, products/services, etc. to a product/service/experience/activity information API (e.g., the product/service/experience/activity information API 135 shown in FIG. 1). The product/service/experience/activity information API can then extract and provide the product/service/experience/activity specific information to the virtual reality retail environment(s) for display on the wrist navigation tool. Accordingly, the retailer online service, the product/service/experience/activity information API, the virtual reality retail environment and the database(s) are communicating in real time and thereby allowing the product/service/experience/activity specific information to be obtained and displayed on the wrist navigation tool within the virtual reality retail environment in real time.

The information and options to be displayed on the wrist navigation tool can be based on one or more of: one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products being prioritized by the retailer online service, services and experiences of the retailer online service currently prioritized by the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc. Based on the information, the wrist navigation tool API can use an algorithm to determine what information and options are to be displayed on the wrist navigation tool. The wrist navigation tool API can prioritize the information and options to be displayed on the wrist navigation tool to increase the ease and accessibility in which the guest can interact with the virtual reality retail environment, increase the entertainment value of the virtual reality retail environment to the guest, and thereby enhance the guest's experience within the virtual reality retail environment.

In some embodiments, the information and options viewable and selectable on the wrist navigation tool can dynamically change in real time based on, for example, one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products, services and experiences of the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc.

At 215, the wrist navigation tool API causes, via a display device (e.g., the VR headset 152 shown in FIG. 1), presentation of a wrist navigation tool within the virtual reality retail environment. In some embodiments, the virtual wrist navigation tool is aligned within a field of view of a guest within the virtual reality retail environment. That is, the wrist navigation tool can be displayed anywhere in the virtual reality retail environment that the guest is looking. The wrist navigation tool can remain aligned within the field of view of the guest as the guest moves or looks around the virtual reality retail environment. The wrist navigation tool API is configured to display the information and options determined at 210.

FIG. 3B illustrates a screenshot of the virtual reality retail environment 300 in which a wrist navigation tool 315 on the arm of the guest avatar 305 is shown upon the guest sending a command to initiate the wrist navigation tool 315. In particular, upon the guest initiating the wrist navigation tool 315, the virtual reality retail environment 300 displays the wrist navigation tool 315 aligned within the field of view of the guest. The guest can use the virtual representation of the VR motion controller 310 (using the guest's input/output device) to input one or more search terms into the wrist navigation tool 315 to search for activities, experiences, products/services, etc. available from the retailer online service. The virtual representation of the VR motion controller 310 includes a pointer 312 to select items and options within the virtual reality retail environment. As shown in FIG. 3B the wrist navigation tool 315 is shown on the left arm of the guest avatar 305. In other embodiments, the wrist navigation tool 315 can be shown on the right arm of the guest avatar 305. In some embodiments, the guest can choose whether the wrist navigation tool 315 is shown on the left arm or the right arm of the guest avatar 305. For example, the guest raise a left VR motion controller to their face to initiate display of the wrist navigation tool 315 on the left arm of the guest avatar 305 and the guest raise a right VR motion controller to their face to initiate display of the wrist navigation tool 315 on the right arm of the guest avatar 305.

FIGS. 4A-L illustrate different schematic representations of a virtual wrist navigation tool within a virtual reality retail environment, according to one embodiment. FIG. 4A illustrates a generic schematic representation of the virtual wrist navigation tool 400, according to one embodiment. The wrist navigation tool 400 includes a search bar segment 405, a shared display segment 410 and a global navigation segment 415.

The search bar segment 405 is configured to allow the guest to search for relevant (or potentially relevant) activities, experiences, products/services, etc. available from the retailer online service. In some embodiments, the search bar segment 405 can include a search bar that allows the user to type or speak keywords to search within the VR platform. In some embodiments, the search bar segment 405 can include navigation tools that allow the user to search and select different products/services for purchase from the retailer and/or different experiences/activities to interact with within the virtual reality retail environment without using a keyword search. For example, the navigation tools can include buttons to search by categories, sets, styles, collections, or decor to identify products for purchase.

The shared display segment 410 is configured to display different information and selectable options based on, for example, what is searched via the search bar segment 405 or what is selected from the global navigation segment 415. In some embodiments, the wrist navigation tool API can be configured to prioritize the information and options to be displayed on the shared display segment 410 to increase the ease and accessibility in which the guest can interact with the virtual reality retail environment, increase the entertainment value of the virtual reality retail environment to the guest, and thereby enhance the guest's experience within the virtual reality retail environment.

In some embodiments, the information and options viewable and selectable on the shared display segment 410 can dynamically change in real time based on, for example, one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products, services and experiences of the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc.

The global navigation segment 415 is configured to display selectable options for the guest to quickly access different areas or functionality of the virtual reality retail environment.

FIG. 4B illustrates a schematic representation of the virtual wrist navigation tool 400 displaying a home display, according to one embodiment. In this embodiment, the search bar segment 405 includes a keyword search bar 407, a search button 408 and a voice search button 409. The keyword search bar 407, when selected by the guest, can open a keyboard in the virtual reality retail environment that allows the guest to type in one or more words to search. The search button 408 allows a guest to initiate a search once the guest has entered one or more words into the keyword search bar 407. The voice search button 409, when selected by the guest, allows the guest to speak one or more keywords for searching.

The shared display segment 410 includes selectable priority buttons 420 that are prioritized by the retailer online service using, for example, the personalization algorithm run by the wrist navigation tool API. In this embodiment, selectable priority button 420a displays a first priority product/service/experience/activity, selectable priority button 420b displays a second priority product/service/experience/activity, selectable priority button 420c displays a third priority product/service/experience/activity, selectable priority button 420d displays a fourth priority product/service/experience/activity, and selectable priority button 420e displays a fifth priority product/service/experience/activity. In some embodiments, the selectable priority buttons 420 can include one or more images indicating the product/service/experience/activity initiated when selected. For example, selectable priority button 420a can display a Halloween experience, a Back to College experience, etc. Selectable priority button 420b can display, for example, the guest's progress within a product design tool (e.g., Home Planner provided by Target Corporation). Selectable priority button 420c can display, for example, a high score within a virtual reality retail environment activity (e.g., a virtual game, etc.). Selectable priority button 420d can display, for example, one or more deals for products/services/activities/experiences available for purchase from the retailer online service. Selectable priority button 420e can display, for example, details regarding the avatar of the guest within the virtual reality retail environment. It will be appreciated that any of the selectable priority buttons 420 can include the products/services/experiences/activities identified above as desired by the retailer online service. In some embodiments, the selectable priority buttons 420a-e can be displayed as a 2D image, a 3D image, a video, an 2D or 3D animation, etc.

This global navigation segment 415 can include, for example, a Home button 417a, a Map button 417b, a Camera button 417c, a Scan Tool button 417d, a Shopping Cart button 417e, a Sign In button 417f, and a Help button 417g. The Help button 417g, when selected by the guest, can initiate the shared display segment 410 to, for example, display tutorials that the guest can use to learn different functionality within the virtual reality retail environment. This can, for example, include: a tutorial indicating how to grab an item within the virtual reality retail environment; a tutorial indicating how to delete an item grabbed by the guest within the virtual reality retail environment; a tutorial indicating how to teleport within the virtual reality retail environment; a tutorial indicating how use a scanner tool within the virtual reality retail environment; a tutorial indicating how to conduct a search within the virtual reality retail environment; a tutorial indicating how to view a model of an item within the virtual reality retail environment; a tutorial indicating how to obtain details of an item within the virtual reality retail environment; a tutorial indicating how to place an item within the virtual reality retail environment; a tutorial indicating how to control the VR motion controller within the virtual reality retail environment; a tutorial teaching basic controls for navigating and operating within the virtual reality retail environment, As shown, the Home button 417a is highlighted and the shared display segment 410 displays selectable priority buttons 420 of the home display. In some embodiments, the global navigation segment 415 can include additional buttons or may not include all of the buttons shown in FIG. 4B as desired, for example, by the retailer, the guest, etc. For example, the global navigation segment 415 can optionally include a Settings button 417h, a Music On/Off button 417i, and a Microphone button 417j. The Settings button 417h, when selected by the guest, can allow the guest to access different settings for adjusting functionality of the virtual reality retail environment, the VR headset, and/or the VR motion controller(s). The Music On/Off button 417i, when selected by the guest, can allow the guest to turn on or off music played through the VR headset. The Microphone button 417j, when selected by the guest, can allow the guest to turn on or off a microphone provided with, for example, the VR headset. In another example, the global navigation segment 415 may not include the scan tool button 417d as discussed in more detail below with respect to FIG. 4I.

FIG. 4C illustrates a schematic representation of the virtual wrist navigation tool 400 displaying a home display when the guest selects the keyword search bar 407, according to one embodiment. In this embodiment, a pointer 412 of a virtual representation of a motion controller (e.g., the virtual representation of the motion controller 310 shown in FIG. 3A) can be used by the guest to select the keyword search bar 407. Upon selection of the keyword search bar 407, a keyboard 423 is displayed above the search bar segment 405. In this embodiment, the search bar segment 405 includes a keyword search bar 407, a search button 408 and a voice search button 409. The keyword search bar 407, when selected by the guest, can open the keyboard 423 in the virtual reality retail environment that allows the guest to type in one or more words to search (i.e., search terms). Once the one or more words are entered by the guest using the keyboard 423, the guest can select the search button 408 for a product/service/experience/activity information API (e.g., the product/service/experience/activity information API 135 shown in FIG. 1) to identify information related to the typed in search terms for display in the shared display segment 410.

In another embodiment, as shown in FIG. 4D, upon selection of the keyword search bar 407, the virtual reality retail environment 401 displays a keyboard 402 aligned within the field of view of the guest. The guest can use the virtual representation of the VR motion controller 411 (using the guest's input/output device) to input one or more search terms into the keyboard 402 to search for products/services available for purchase from the retailer online service. In this example, the guest has used the keyboard 402 to type in the search term “couch” as displayed in the keyword search bar 419. Upon the guest selecting the search button 408, a product/service/experience/activity information API (e.g., the product/service/experience/activity information API 135 shown in FIG. 1) can be used to identify information related to the typed in search terms for display in the virtual reality retail environment 401. An advantage of this embodiment is that the guest is not required to hold up their wrist to enter one or more search terms. Once the one or more words are entered by the guest using the keyboard 402, the guest can select the search button 403 for a product/service/experience/activity information API (e.g., the product/service/experience/activity information API 135 shown in FIG. 1) to identify information related to the typed in search terms for display in virtual reality retail environment 401.

The keyboard 402 also includes a keyboard removal button 404, a filter button 406, a keyboard button 416, a pickup button 421, a shop in store button 422, a shipping button 424, and a same day delivery button 426. The keyboard removal button 404, when selected by the guest, is configured to remove display of the keyboard 402 from the virtual reality retail environment 401. The filter button 406 is configured to instruct the virtual reality retail environment 401 to display a filter display (e.g., a filter display 413 shown in FIG. 4G) to filter search options as opposed to displaying the keyboard 402. The keyboard button 416 is configured to instruct the virtual reality retail environment 401 to maintain display of the keyboard 402 as opposed to displaying the filter display. The pickup button 421, when selected by the guest, is configured to instruct the retailer online service (e.g., the retailer online service 110 shown in FIG. 1) to add the selected search result as an item for purchase in the guest's associated electronic shopping cart with a pickup option at a guest designated retail store selected (see, for example, FIGS. 4J and 4K). The shop in store button 422, when selected by the guest, is configured to instruct the virtual reality retail environment 401 to display whether the selected search result is available for purchase at a guest designated retail store. In some embodiments, the shop in store button 422, when selected by the guest, is configured to instruct the virtual reality retailer environment 401 to display where in a guest designated retail store the selected search result is located (e.g., aisle number, section number, product area, etc.). The shipping button 424, when selected by the guest, is configured to instruct the retailer online service to add the selected search result as an item for purchase in the guest's associated electronic shopping cart with a shipping option selected for delivery to a guest selected address. The same day delivery button 426, when selected by the guest, is configured to instruct the retailer online service to add the selected search result as an item for purchase in the guest's associated electronic shopping cart with a same day delivery option selected for delivery to a guest selected address.

FIG. 4E illustrates a schematic representation of the virtual wrist navigation tool 400 displaying a home display when the guest selects the search button 408 after typing one or more search terms into the keyword search bar 407 or the keyboard 402, according to one embodiment. In this example, the guest has entered the search terms “Green Sofa”. The shared display segment 410 displays the search results 427 along with filtering options 425 relevant to the search terms “Green Sofa”. Each of the search results 427 are displayed as a card. In this example, the filtering options 425 includes, for example, a “Size” filtering option 425a, a “Type” filtering option 425b, a “Price” filtering option 425c, a “Color” filtering option 425d, and a “Rating” filter option 425e. Each of the search results 427 is displayed as a card that includes at least some product/service/experience/activity specific information obtained from the database including: a picture of the product/service/experience/activity available for purchase from the retailer online service; a name of the product/service/experience/activity; a company name of a company associated with the product/service/experience/activity; a rating of the product/service/experience/activity; color options of the product/service/experience/activity; a price of the product/service/experience/activity; an “Add to Scene” selectable option; an “Add to Cart” selectable option, etc. It will be appreciated that in some embodiments, the shared display segment 410 may not be able to display all of the search results 427. In some embodiments, the shared display segment 410 also includes selectable page options 429 that can indicate to the guest which page of the search results 427 are being displayed in the shared display segment 410 and allow the guest to move between different pages of the search results 427.

In other embodiments, as shown in FIG. 4F, when the guest selects the search button 408 after typing one or more search terms into the keyword search bar 407 or the keyboard 402, the virtual reality retail environment 401 can display search results 418 along with filtering options 414 aligned within the field of view of the guest. Each of the search results 418 is displayed as a card that includes at least some product/service/experience/activity specific information obtained from the database including: a picture of the product/service/experience/activity available for purchase from the retailer online service; a name of the product/service/experience/activity; a company name of a company associated with the product/service/experience/activity; a rating of the product/service/experience/activity; color options of the product/service/experience/activity; a price of the product/service/experience/activity; an “Add to Scene” selectable option; an “Add to Cart” selectable option, etc. In this example, the guest has entered the search term “couch” into the keyboard search bar 419. The virtual reality retail environment 401 can also display the number of search results and the number of pages of search results above the search results 418 and provide an arrow button 428 to allow the guest to view another page of search results. In some embodiments, the search results 427, 418 can be displayed as 3D cards as part of a card ecosystem guest interface as disclosed in U.S. application Ser. No. 18/486,558, which is incorporated herein by reference in its entirety.

When the guest selects the filter button 406, the keyboard 402 can be replaced with a filter display 413, as shown in FIG. 4G. The filter display 413 includes one or more filtering options 414 relevant to the search term entered into the keyboard search bar 419. In this example, the filtering options 414 are relevant to the search term “couch” and include, for example, an “Age” option, a “Brand” option, a “Decor Style” option, an “Upholstered” option, a “Price” option, a “Sold By” option, a “Shipping and Pickup” option, a “Type” option, a “Color” option, an “Upholstry” option, a “Seat Material” option, a “Sofas Size” option, a “Futons Size” option, etc. The guest can use the pointer 412 to select a desired filtering option 414 to narrow the search results and thereby the number of search results (e.g., cards) 418 displayed within the virtual reality retail environment 401. An advantage of this embodiment is that the guest is not required to hold up their wrist to view search results on the shared display segment 410 of the wrist navigation tool 400. FIG. 4H illustrates a schematic representation of the virtual wrist navigation tool 400 upon selection of the Map button 417b, according to one embodiment. As shown, the Map button 417b is highlighted and the shared display segment 410 displays a map 430 of the virtual reality retail environment. The map 430 includes a plurality of selectable locations 432 within the virtual reality retail environment. In this example, the selectable locations 432 includes a Hub location 432a, a Product Design Tool location 432b, an Apparel and Accessories location 432c, a Promotional location 432d, an Experience location 432e, and an Activity location 432f. The map 430 also includes a star indicating where in the virtual reality retail environment the avatar of the guest is currently located. In this example, the map 430 shows that the guest is in the Product Design location 432b. The guest can use the virtual wrist navigation tool 400 to select one of the selectable locations 432 in order to transport the avatar of the guest to that location within the virtual reality retail environment. In another embodiment, when the guest selects the map button 417b, the virtual reality retail environment can display the map 430 aligned within the field of view of the guest without requiring the guest to hold up their wrist to view the map 430 of the wrist navigation tool 400.

FIG. 4I illustrates a schematic representation of the virtual wrist navigation tool 400 upon selection of the Camera button 417c, according to one embodiment. As shown, the Camera button 417c is highlighted and the shared display segment 410 shows items relevant to the virtual camera. In this embodiment, the shared display segment 410 displays a gallery of videos/pictures 435a, 435b taken by the virtual camera within the virtual reality retail environment. In this example, the shared display segment 410 provides video/picture information 436, a share option 437, and a delete option 438 below each of the one or more video/pictures 435. The video/picture information 436 includes, for example, an experience name being experienced when the video/picture was taken, a date when the video/picture was taken, and a time when the video/picture was taken. It will be appreciated that in other embodiments, the video/picture information 436 can include additional information including, for example, a virtual reality retail environment location where the video/picture was taken, any guest avatars in the video/picture, any products/items tagged in the video/picture, etc. The share option 437, when selected by the guest, can be configured to allow the guest to share the associated video/picture 435 to others through the virtual reality retail environment. In some embodiments, the share option 437, when selected by the guest, can initiate a social media API that allows the guest to share the video/picture 435 via the retailer's own social media application or a third-party social media application. The delete option 438, when selected by the guest, can be configured to delete or remove the associated video/picture 435 from the guest's virtual reality retail environment. In some embodiments, selection of the Camera button 417c can also initiate a Heads Up Display (HUD) within the virtual reality retail environment that allows the guest to take a virtual picture or video within the virtual reality retail environment. In another embodiment, when the guest selects the Camera button 417c, the virtual reality retail environment can display the Camera aligned within the field of view of the guest without requiring the guest to hold up their wrist.

FIG. 4J illustrates a schematic representation of the virtual wrist navigation tool 400 upon selection of the Scan Tool button 417d, according to one embodiment. When selected, the Scan Tool button 417d is configured to initiate a scan tool that allows the guest to scan various objects within the virtual reality retail environment. When the scan tool scans an object disposed within the virtual reality retail environment, a scan tool API is configured to identify the object and associate the object as a product or service that is available for purchase from the retailer online service. The scan tool API can then obtain information from the database about the scanned product or service and display the information in the shared display segment 410. As shown, when the scan tool scans an object disposed within the virtual reality retail environment, the shared display segment 410 displays a card 440 with information regarding the product or service, a Purchase button 442, and a Product Design button 444. In this example, the card 440 includes: a picture of the scanned product or service; a name of the product or service; a company name of a company associated with the product or service; and a price of the product/service. It will be appreciated that in other embodiments, the card 440 can include additional or less information for display in the shared display segment 410. In some embodiments, a scanned object can be automatically saved to an electronic shopping cart to an account associated with the guest. As shown in FIG. 4J, the Shopping Cart button 417e can indicate the number of products/services added to the electronic shopping cart associated with the guest. In this example, the electronic shopping cart includes three products/services for purchase from the retailer online service. In some embodiments, when an object in the virtual reality retail environment is scanned by the scan tool, the scanned object can be automatically added to the electronic shopping cart associated with the guest. Accordingly, the wrist navigation tool API can increment the number displayed on the Shopping Cart button 417e. The Purchase button 442, when selected by the guest, is configured to initiate an electronic shopping cart API (e.g., the electronic shopping cart API 125) to finalize the guest purchase of the product or service associated with the scanned object. The Product Design button 444, when selected by the guest, is configured to provide the product or service associated with the scanned object to a Product Design tool of the retailer online service. In another embodiment, when the guest selects the Scan Tool button 417d, the virtual reality retail environment can display the scan tool aligned within the field of view of the guest without requiring the guest to hold up their wrist.

As discussed above, the scan tool can be manually initiated by selecting the Scan Tool button 417d. In some embodiments, the scan tool can be automatically initiated using a VR motion controller. For example, the scan tool can be automatically initiated when the guest uses the VR motion controller to interact with an object within the virtual reality retail environment and the object is a product or service that is available for purchase from the retailer online service. That is, the VR motion controller can include a first button or trigger that allows the guest avatar to grip and manipulate the object within the virtual reality retail environment and can include a second button or trigger that allows the guest avatar to trigger the scan tool to scan the object. If the object, for example, is not a product or service that is available for purchase from the retailer online service, the second button or trigger can allow the guest avatar to interact with the object. For example, if the object is a boom box that is not a product or service that is available for purchase from the retailer online service, the second trigger can cause the boom box to play music or turn off music already being played by the boom box.

FIG. 4K illustrates a schematic representation of the virtual wrist navigation tool 400 upon selection of the Shopping Cart button 417e, according to one embodiment. As shown, the Shopping Cart button 417e is highlighted and the shared display segment 410 shows an electronic shopping cart with any products and or services the guest has selected for purchase from the online retailer service. In some embodiments, the wrist navigation tool API can communicate with an electronic shopping cart API (e.g. the electronic shopping cart API 135) to retrieve any products or services in a shopping cart associated with the guest. In this embodiment, the shared display segment 410 displays each of the products or services 445 stored in the electronic shopping cart associated with the guest. In this example, the shared display segment 410 displays the product or service 445a as a card, a Link to Retailer option 447, and a Delete option 449. The card, similar to each of the search results 427, includes at least some product/service specific information obtained from the database including: a picture of the product/service available for purchase from the retailer online service; a name of the product/service; a company name of a company associated with the product/service; a rating of the product/service; color options of the product/service; a price of the product/service; an “Add to Scene” selectable option; an “Add to Cart” selectable option, etc. In some embodiments, the Link to Retailer option 447, when selected by the guest, can initiate the retailer online service to provide a sign in to allow the guest to link an account with the retailer online service to the guest avatar in the virtual reality retail environment. Selection of the Link to Retailer option 447 is discussed below with respect to FIG. 4L. The delete option 449, when selected by the guest, can be configured to delete or remove any of the products or services 445 from the electronic shopping cart. In another embodiment, when the guest selects the Shopping Cart button 417e, the virtual reality retail environment can display the electronic shopping cart aligned within the field of view of the guest without requiring the guest to hold up their wrist with features similar to those discussed above with respect to FIG. 4K.

FIG. 4L illustrates a schematic representation of the virtual wrist navigation tool 400 when the guest is attempting to link the guest avatar to an account with the retailer online service, according to one embodiment. In this embodiment, the shared display segment 410 displays an account name bar 452, a password bar 454, a Login Help button 456, a Sign In button 458, Retailer Terms and Conditions button 460, and a Retailer Privacy Policy button 462. This example of the shared display segment 410 can be initiated, for example, upon the guest selecting the Sign In button 417f or upon selecting the Link to Retailer option 447 (shown in FIG. 4K). In this example, the Shopping Cart button 417e is highlighted which can indicate that the guest initiated the sign in option via selection of the Link to Retailer option 447. The account name bar 452, when selected, allows the guest to enter an account name (e.g., an email address, a username, a mobile phone number, etc.) associated with an account for the retailer online service. In some embodiments, selection of the account name bar 452 can initiate display of a keyboard (e.g., the keyboard 423 shown in FIG. 4C, the keyboard 402 shown in FIG. 4D, etc.) in the virtual reality retail environment that allows the guest to type in the account name. The password bar 454, when selected, allows the guest to enter a password associated with the account name. In some embodiments, selection of the password bar 454 can initiate display of a keyboard (e.g., the keyboard 423 shown in FIG. 4C, the keyboard 402 shown in FIG. 4D, etc.) in the virtual reality retail environment that allows the guest to type in the password. The Login Help button 456, when selected by the guest, can initiate options in the shared display segment 410 that allows the user to recover, for example, an account name or password. The Sign In button 458, when selected by the guest, can initiate sign in to the account upon proper entry of the account name and password. The Retailer Terms and Conditions button 460, when selected by the guest, can initiate the shared display segment 410 to provide information about the retailer's terms and conditions. The Retailer Privacy Policy button 462, when selected by the guest, can initiate the shared display segment 410 to provide information about the retailer's privacy policy. In another embodiment, when the guest attempts to link the guest avatar to an account with the retailer online service, the virtual reality retail environment can display features similar to those discussed above with respect to FIG. 4L.

Returning to FIG. 2, upon presentation of the wrist navigation tool within the virtual reality retail environment, the method 200 then proceeds to 220.

At 220, the wrist navigation tool API waits to receive a selection command to select an option provided in at least one of the shared display segment and the global navigation segment from the guest. In some embodiments, the guest can send a command through the user device using, for example, the input/output device connected to the user device. For example, a guest can press button(s) or control(s) on a VR motion controller to interact with the wrist navigation tool. That is, for example, the guest can select one or more virtual button(s) located on the virtual wrist navigation tool. The selection command can include, for example, any of the buttons 417 provided in the global navigation segment 415, any of the selectable options, buttons or bars shown in the shared display segment 410, or any of the selectable options, buttons or bars shown in the search bar segment 405 shown in FIGS. 4A-L.

Upon receiving the selection command, the method 200 then proceeds to 225.

At 225, the wrist navigation tool API is configured to update information and options to be displayed on the wrist navigation tool based on the selection command received at 220. In some embodiments, database(s) (e.g., the databases 160) can provide updated information and options for the identified relevant (or potentially relevant) activities, experiences, products/services, etc. to a product/service/experience/activity information API (e.g., the product/service/experience/activity information API 135 shown in FIG. 1) based on the selection command. The product/service/experience/activity information API can then extract and provide the updated product/service/experience/activity specific information to the virtual reality retail environment(s) for display on the wrist navigation tool. Accordingly, the retailer online service, the product/service/experience/activity information API, the virtual reality retail environment and the database(s) are communicating in real time and thereby allowing the updated product/service/experience/activity specific information to be obtained and displayed on the wrist navigation tool within the virtual reality retail environment in real time.

While the updated information and options to be displayed on the wrist navigation tool is primarily based on the selection command received at 220, the updated information and options can also be based on one or more of: one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products being prioritized by the retailer online service, services and experiences of the retailer online service being prioritized by the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc. Based on the information, the wrist navigation tool API can determine what information and options are to be displayed on the wrist navigation tool. The wrist navigation tool API can use an algorithm to prioritize the information and options to be displayed on the wrist navigation tool to increase the ease and accessibility in which the guest can interact with the virtual reality retail environment, increase the entertainment value of the virtual reality retail environment to the guest, and thereby enhance the guest's experience within the virtual reality retail environment.

In some embodiments, the updated information and options viewable and selectable on the wrist navigation tool can also dynamically change in real time based on, for example, one or more previous experiences and/or activities participated by the guest within the virtual reality retail environment, one or more previous locations visited by the guest within the virtual reality retail environment, a current location of the guest avatar within the virtual reality retail environment, a current geographic location of the guest, a time of day where the guest is geographically located, the current day of the year, current promotional products, services and experiences of the retailer online service, previous search history and queries by the guest (obtained, for example, through the retailer online service, obtained by cookies on the user device, etc.), previous purchases by the user from the retailer online service, contents, product(s) and/or service(s) currently in a shopping cart associated with the guest, etc. Depending on the selection command, the method 200 then proceeds to at least one of 230 and 235.

At 230, the wrist navigation tool API causes, via the display device (e.g., the VR headset 152 shown in FIG. 1), presentation of an updated wrist navigation tool within the virtual reality retail environment that is updated based on the selection command. In some embodiments, the shared display segment is updated to include at least some of the updated information and options determined at 225. In some embodiments, the global navigation segment (e.g., the global navigation segment 415 shown in FIGS. 4A-L) can also be updated based on the selection command. For example, any of the buttons provided in the global navigation segment (e.g., the buttons 417 of the global navigation segment 415 shown in FIGS. 4A-L) can be highlighted when the selection command is the guest selecting a particular button of the global navigation segment. The method 200 then proceeds back to 220.

At 235, the wrist navigation tool API causes, via the display device, the guest avatar to be transported to a different location within the virtual reality retail environment. For example, when the guest selects a selectable location of a map provided in the shared display segment (e.g., one of the selectable locations 432 of the map 430 shown in FIG. 4H), the wrist navigation tool API can transport the guest avatar to the selected location within the virtual reality retail environment. The method 200 then proceeds back to 220.

FIG. 5 is a schematic diagram of architecture for a computer device 900, according to an embodiment. The computer device 900 and any of the individual components thereof can be used for any of the operations described in accordance with any of the computer-implemented methods described herein.

The computer device 900 generally includes a processor 910, memory 920, a network input/output (I/O) 925, storage 930, and an interconnect 950. The computer device 900 can optionally include a user I/O 915, according to some embodiments. The computer device 900 can be in communication with one or more additional computer devices 900 through a network 940.

The computer device 900 is generally representative of hardware aspects of a variety of user devices 901 and a server device 935. The illustrated user devices 901 are examples and are not intended to be limiting. Examples of the user devices 901 include, but are not limited to, a desktop computer 902, a cellular/mobile phone 903, a tablet device 904, and a laptop computer 905. It is to be appreciated that the user devices 901 can include other devices such as, but not limited to, a wearable device, a personal digital assistant (PDA), a video game console, a television, or the like. In an embodiment, the user devices 901 can alternatively be referred to as client devices 901. In such an embodiment, the client devices 901 can be in communication with the server device 935 through the network 940. One or more of the client devices 901 can be in communication with another of the client devices 901 through the network 940 in an embodiment.

The processor 910 can retrieve and execute programming instructions stored in the memory 920 and/or the storage 930. The processor 910 can also store and retrieve application data residing in the memory 920. The interconnect 950 is used to transmit programming instructions and/or application data between the processor 910, the user I/O 915, the memory 920, the storage 930, and the network I/O 940. The interconnect 950 can be, for example, one or more busses or the like. The processor 910 can be a single processor, multiple processors, or a single processor having multiple processing cores. In some embodiments, the processor 910 can be a single-threaded processor. In an embodiment, the processor 910 can be a multi-threaded processor.

The user I/O 915 can include a display 916 and/or an input 917, according to an embodiment. It is to be appreciated that the user I/O 915 can be one or more devices connected in communication with the computer device 900 that are physically separate from the computer device 900. For example, the display 916 and input 917 for the desktop computer 902 can be connected in communication but be physically separate from the computer device 900. In some embodiments, the display 916 and input 917 can be physically included with the computer device 900 for the desktop computer 902. In an embodiment, the user I/O 915 can physically be part of the user device 901. For example, the cellular/mobile phone 903, the tablet device 904, and the laptop 905 include the display 916 and input 917 that are part of the computer device 900. The server device 935 generally may not include the user I/O 915. In an embodiment, the server device 935 can be connected to the display 916 and input 917.

The display 916 can include any of a variety of display devices suitable for displaying information to the user. Examples of devices suitable for the display 916 include, but are not limited to, a cathode ray tube (CRT) monitor, a liquid crystal display (LCD) monitor, a light emitting diode (LED) monitor, or the like.

The input 917 can include any of a variety of input devices or input means suitable for receiving an input from the user. Examples of devices suitable for the input 917 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 917 can be included for the user devices 901. In some embodiments the input 917 can be integrated with the display 916 such that both input and output are performed by the display 916.

The memory 920 is generally included to be representative of a random access memory such as, but not limited to, Static Random Access Memory (SRAM), Dynamic Random Access Memory (DRAM), or Flash. In some embodiments, the memory 920 can be a volatile memory. In some embodiments, the memory 920 can be a non-volatile memory. In some embodiments, at least a portion of the memory can be virtual memory.

The storage 930 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 930 is a computer readable medium. In some embodiments, the storage 930 can include storage that is external to the computer device 900, such as in a cloud.

The network I/O 925 is configured to transmit data via a network 940. The network 940 may alternatively be referred to as the communications network 940. Examples of the network 940 include, but are not limited to, a local area network (LAN), a wide area network (WAN), the Internet, or the like. In some embodiments, the network I/O 925 can transmit data via the network 940 through a wireless connection using Wi-Fi, Bluetooth, or other similar wireless communication protocols. In some embodiments, the computer device 900 can transmit data via the network 940 through a cellular, 3G, 4G, or other wireless protocol. In some embodiments, the network I/O 925 can transmit data via a wire line, an optical fiber cable, or the like. It is to be appreciated that the network I/O 925 can communicate through the network 940 through suitable combinations of the preceding wired and wireless communication methods.

The server device 935 is generally representative of a computer device 900 that can, for example, respond to requests received via the network 940 to provide, for example, data for rendering an online service (e.g., a website, an app, etc.) on the user devices 901. The server 935 can be representative of a data server, an application server, an Internet server, or the like.

Aspects described herein can be embodied as a system, method, or a computer readable medium. In some embodiments, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

An embodiment can be provided to an end-user through a cloud-computing infrastructure. Cloud computing generally includes the provision of scalable computing resources as a service over a network (e.g., the Internet or the like).

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A computer-implemented method to present a graphical user interface in a virtual reality retail environment of a retailer online service, the computer-implemented method comprising:
receiving, via an input device, a wrist navigation tool command to present a wrist navigation tool within the virtual reality retail environment;
upon receiving the wrist navigation tool command, determining information and options to be displayed on the wrist navigation tool;
causing, via a display device, presentation of the wrist navigation tool within the virtual reality retail environment, the wrist navigation tool being aligned within a field of view of a guest, and the wrist navigation tool including a search bar segment, a shared display segment, and a global navigation segment, wherein the shared display segment includes the information and the options determined to be displayed on the wrist navigation tool;
receiving, via the input device, a selection command to select an option provided in at least one of the shared display segment and the global navigation segment;
upon receiving the selection command:
determining updated information and options to be displayed on the wrist navigation tool, and
causing, via the display device, at least one of:
presenting an updated shared display segment with the updated information and options on the wrist navigation tool based on the selection command, and
transporting a guest avatar of the guest to a different location within the virtual reality retail environment based on the selection command.

2. The computer-implemented method of claim 1, further comprising:
receiving, via the input device, a second selection command to select a selectable location provided in at least one of the shared display segment and the global navigation segment; and
transporting the guest avatar of the guest within the virtual retail reality environment to a location associated with the selectable location selected by the second selection command.

3. The computer-implemented method of claim 1, further comprising, upon the guest selecting a home button of the global navigation segment, displaying in the shared display segment one or more selectable priority buttons for directing the guest to one of a product, service, experience, and activity, wherein the one or more selectable priority buttons are prioritized by the retailer online service.

4. The computer-implemented method of claim 1, further comprising, upon the guest selecting a keyword search bar of the search bar segment, displaying a virtual keyboard above the search bar segment that is configured to allow the guest to type in one or more search terms to identify information related to the one or more search terms for display in the shared display segment.

5. The computer-implemented method of claim 1, further comprising, upon the guest selecting a map button of the global navigation segment, displaying in the shared display segment a map that includes one or more selectable locations for transporting the guest avatar to another location within the virtual reality retail environment.

6. The computer-implemented method of claim 1, further comprising, upon the guest selecting a camera button of the global navigation segment, displaying in the shared display segment a gallery of one or more pictures or videos taken by a virtual camera within the virtual reality retail environment.

7. The computer-implemented method of claim 1, further comprising, upon the guest selecting a scan tool button of the global navigation segment, initiating a scan tool configured to allow the guest to scan an object disposed within the virtual reality retail environment;
identifying and associating a scanned object as a product or service that is available for purchase from the retailer online service; and
displaying in the shared display segment a card with information regarding the product or service.

8. The computer-implemented method of claim 1, further comprising, upon the guest selecting a shopping cart button of the global navigation segment, displaying in the shared display segment any products or services stored in an electronic shopping cart associated with the guest.

9. A system configured to present a graphical user interface in a virtual reality retail environment, the system comprising:
a retailer online service that is configured to:
receive, via an input device, a wrist navigation tool command to present a wrist navigation tool within the virtual reality retail environment;
upon receiving the wrist navigation tool command, determine information and options to be displayed on the wrist navigation tool;
cause, via a display device, presentation of the wrist navigation tool within the virtual reality retail environment, the wrist navigation tool being aligned within a field of view of a guest, and the wrist navigation tool including a search bar segment, a shared display segment, and a global navigation segment, wherein the shared display segment includes the information and the options determined to be displayed on the wrist navigation tool;
receive, via the input device, a selection command to select an option provided in at least one of the shared display segment and the global navigation segment;
upon receiving the selection command:
determine updated information and options to be displayed on the wrist navigation tool, and
cause, via the display device, at least one of:
presentation of an updated shared display segment with the updated information and options on the wrist navigation tool based on the selection command, and
transport of a guest avatar of a guest to a different location within the virtual reality retail environment based on the selection command.

10. The computer-implemented system of claim 9, wherein the retailer online service is configured to:
receive, via the input device, a second selection command to select a selectable location provided in at least one of the shared display segment and the global navigation segment; and
transport the guest avatar of the guest within the virtual retail reality environment to a location associated with the selectable location selected by the second selection command.

11. The computer-implemented system of claim 9, wherein the retailer online service is configured to:
upon the guest selecting a home button of the global navigation segment, display in the shared display segment one or more selectable priority buttons for directing the guest to one of a product, service, experience, and activity, wherein the one or more selectable priority buttons are prioritized by the retailer online service.

12. The computer-implemented system of claim 9, wherein the retailer online service is configured to:
upon the guest selecting a keyword search bar of the search bar segment, display a virtual keyboard above the search bar segment that is configured to allow the guest to type in one or more search terms to identify information related to the one or more search terms for display in the shared display segment.

13. The computer-implemented system of claim 9, wherein the retailer online service is configured to:
upon the guest selecting a map button of the global navigation segment, display in the shared display segment a map that includes one or more selectable locations for transporting the guest avatar to another location within the virtual reality retail environment.

14. The computer-implemented system of claim 9, wherein the retailer online service is configured to:
upon the guest selecting a camera button of the global navigation segment, display in the shared display segment a gallery of one or more pictures or videos taken by a virtual camera within the virtual reality retail environment.

15. The computer-implemented system of claim 9, wherein the retailer online service is configured to:
upon the guest selecting a scan tool button of the global navigation segment, initiate a scan tool configured to allow the guest to scan an object disposed within the virtual reality retail environment;
identify and associate a scanned object as a product or service that is available for purchase from the retailer online service; and
display in the shared display segment a card with information regarding the product or service.

16. The computer-implemented system of claim 9, wherein the retailer online service is configured to:
upon the guest selecting a shopping cart button of the global navigation segment, display in the shared display segment any products or services stored in an electronic shopping cart associated with the guest.
